(19) United States
(12) Patent Application Publication
(10) Pub. No.: US 2003/0214740 A1
(43) Pub. Date: Nov. 20, 2003

(54) Installation frame for a color wheel assembly of a projection apparatus

(75) Inventors: Li-Kuan Wong, Keelung City (TW); Chia-Yu Liu, Lung Tan Hsiang (TW); Chang-Chien Li, Hsin Chuan City (TW)

Correspondence Address: BRUCE H. TROXELL, SUITE 1404, 5205 LEESBURG PIKE, FALLS CHURCH, VA, 22041, US

(73) Assignee: Benq Corporation

(21) Appl. No.: 10/428,117

(22) Filed: May 2, 2003

(30) Foreign Application Priority Data
May 17, 2002 (TW) 91207147

(51) Int. Cl. G02B 5/22; G02B 7/00

(52) U.S. Cl. 359/892; 359/885

(57) ABSTRACT

An installation frame for a color wheel assembly of a projection apparatus, for firmly installing the color wheel assembly on a chassis of the apparatus, includes a base to be fixed on the chassis, a holding end for fastening the color wheel assembly, and a body connecting the base and the holding end. In particularly, the body forms a triangle to have the base as a side of the triangle and the holding end positioned at an angle opposing to the side. By providing the installation frame, the color wheel assembly can be isolated in construction from a cooperated optical device so as to reduce the entire operational noise level of the apparatus.

### FIELD OF THE INVENTION

The present invention relates to an installation frame for a color wheel assembly of a projection apparatus, more particularly, to a construction of installing a color wheel assembly by using a framed component which is structurally separated from an optical device to increase the operating stability of a color wheel.

### BACKGROUND OF THE INVENTION

In the application technology of an image display system, a spatial light modulator (SLM) and a cathode ray tube (CRT) are two mainstreams of such a technology. Especially, the digital SLM technology is more advanced and can provide higher resolution.

In practice of the SLM technology, a digital micro-mirror device (DMD) is a well-known product developed by Texas Instruments Incorporated Company, U.S.A. and is widely employed in the image direct-view or projection system. The color wheel component of this invention is one of the important elements for practicing DMDs. Since the technology of integral image forming for the DMD is irrelevant to the installation frame for a color wheel assembly of the present invention, it will not be described herein.

Please refer to FIG. 1, which is a schematic three-dimensional diagram illustrating a DMD module employed in a projection apparatus, wherein the DMD module 3 is disposed along a light path 800 between a set of lens 4 and an optical device 2. A color wheel 7 is disposed along the light path 800 behind a light source 6 and a feeding slot 5. As shown in FIG. 1, in the conventional apparatus, the color wheel 7 is activated by a color wheel motor 71 mounted at the central axle of the color wheel 7 and is rotated in a color wheel operating tank 70 with a high speed (about 7000 RPM). The color wheel motor 71 is erected through a thin plate 710 thereof on a set-up plate 21 extended from the wall of the color wheel operating tank 70 by means of three fixing screws 23 so that the color wheel 7 can have a fixed position in relation to the light path 800 of the optical device 2.

Generally, the application of the DMD module 3 and the color wheel 7 in the SLM technology may produce a better effect of image forming, but it suffers a louder operating noise in comparison with the CRT module. With development of projection apparatuses into a home theatre model, consumers' requirements for quality of noise are getting stricter. Therefore, how to maintain a high image quality of the DMD technology as well as to reach to the requirement of low undesired sound is the focus of the present invention.

Profoundly considering the practice of the DMD technology, it can be found that the major source of noise of the DMD technology resides in the vibration sound produced by operation of the color wheel 7. As shown in FIG. 1, the color wheel 7 is fixed merely by means of three small-scale fixing screws 23 which directly fasten the thin plate 710 used to fix the color wheel motor 71 onto the set-up plate 21 extended from the color wheel operating tank 70. This substantially forms an attachment of a metal-to metal vertical cantilever. However, it is obviously improper in the vibration theory that the sum of weights of the color wheel 7 and the color wheel motor 71 is loaded on the end of a plate piece (i.e. the set-up plate 21), let alone that the operation rotating speed of the color wheel 7 is more than thousands RPM. Moreover, the optical device 2 to which the color wheel operating tank 70 is attached is fastened with a chassis 1 used as a set-up platform. When the casing of the projection apparatus is made of metal, the vibration and noise produced by the rotation of the color wheel motor 71 and the color wheel 7 will be transferred to the entire apparatus, and thus the noise level of such designed product is usually above 35 dB.

Hence, there is a need to diminish the operating noise of a color wheel assembly.

### SUMMARY OF THE INVENTION

The primary objective of the present invention is to provide an installation frame for a color wheel assembly of a projection apparatus. The color wheel motor and the color wheel assembly are independently mounted on the housing of the projection apparatus by a secure installation component so as to reduce the noise and vibration produced during the operation thereof.

In one embodiment of this invention, an installation frame for a color wheel assembly of a projection apparatus is disclosed and is used to securely install a color wheel assembly. The projection apparatus comprises a chassis, and the installation frame for a color wheel assembly comprises a base to be fixed on the chassis by means of a plurality of connecting elements, a holding end for fastening the color wheel assembly, and a body connecting the base and the holding end in a triangle configuration. In particularly, the body forms a triangle to have the base as a side of the triangle and the holding end positioned at an angle opposing to the side. By providing the installation frame, the color wheel assembly can be isolated in construction from an optical device so as to reduce the entire operational noise level of the apparatus.

In this invention, the connecting element is mainly used to securely fasten the installation frame on the chassis of the projection apparatus. The embodiment thereof can be a screw or other fixing components or mechanisms with similar functions.

In this invention, in order to enhance the isolation of the installation frame on the chassis and to decrease the effect of the operating vibration of the color wheel upon the other components on the chassis of the projection apparatus, a shock absorbing rubber, a compression spring or other materials which may absorb shock and cushion vibration can be disposed on the connecting elements of the installation frame or between the base of the installation frame and the chassis.

In this invention, the installation frame is preferably configured in a piece and can be an aluminum product, a casting, a plastic article or articles made of other materials; wherein a plastic article is preferred, considering the shock absorbing property of material.

In this invention, in order to strengthen the firmness of the installation frame in a third direction, at least one reinforcing rib can be mounted on the body of the installation frame.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic three-dimensional diagram illustrating part of the interior of a projection apparatus in the prior art;

FIG. 2 is a schematic three-dimensional exploded diagram illustrating one embodiment of the installation frame for a color wheel assembly in accordance with the present invention employed in the optical device of the projection apparatus of FIG. 1;

FIG. 3 is a schematic three-dimensional diagram of the construction of FIG. 2 assembled in the projection apparatus of FIG. 1;

FIG. 4 is a schematic cross-sectional view of another embodiment of the installation frame for a color wheel assembly in accordance with the present invention; and

FIG. 5 is a schematic cross-sectional view of the other embodiment of the installation frame for a color wheel assembly in accordance with the present invention.

### DETAILED DESCRIPTION OF THE PREFERRED EMBODIMENT

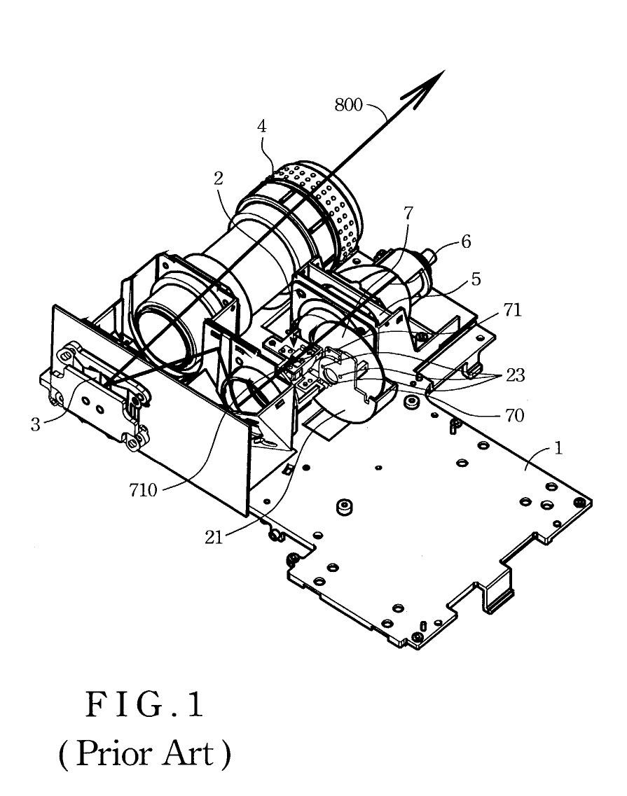

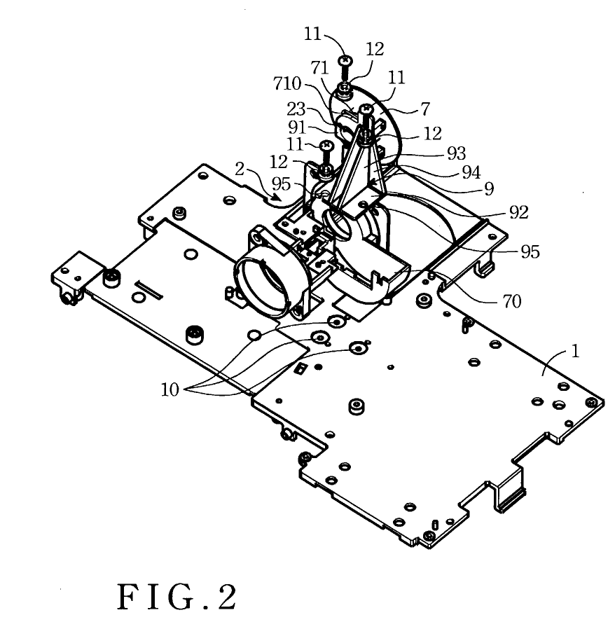

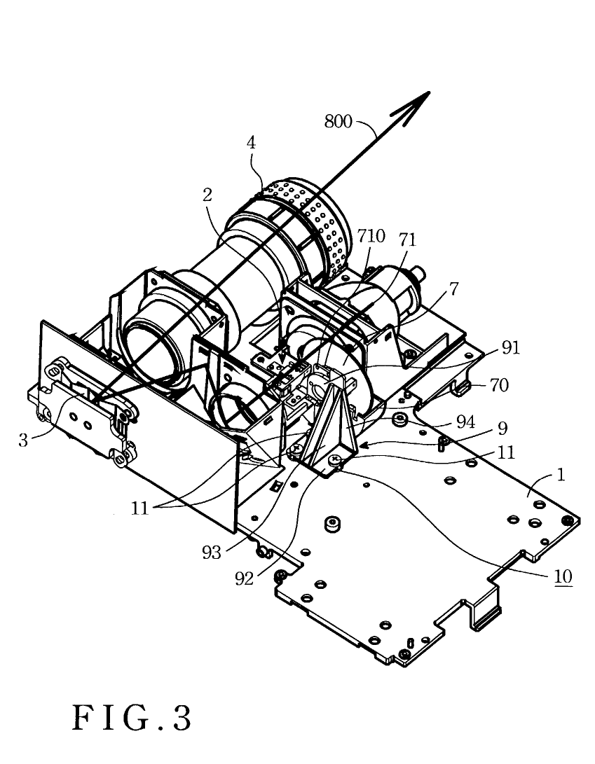

Please refer to FIGS. 2 and 3, which are respectively schematic three-dimensional exploded and combined diagrams illustrating one embodiment of the installation frame for a color wheel assembly in accordance with the present invention employed in the optical device of the projection apparatus of FIG. 1. The installation frame 9 of this invention is used to provide an installation basis to secure the color wheel assembly of the thin plate 710, the color wheel motor 71 and the color wheel 7, thereby to diminish the vibration of the color wheel assembly itself during operating as well as to avoid propagation of such a vibration and influence on the other components.

As shown in FIGS. 2 and 3, the projection apparatus comprises a chassis 1 as a set-up platform for carrying the optical device 2 and the installation frame 9. The installation frame 9 is mounted on the chassis 1 adjacent to the color wheel operating tank 70 so as to keep the color wheel 7 in the original operating position (please compare FIG. 1 with FIG. 3). The installation frame 9 of this invention comprises a base 92, a holding end 91 and a body 93; wherein the installation frame 9 can be fixed through the base 92 thereof on the chassis 1 by means of a plurality of connecting elements 11; the holding end 91 is formed as a plate piece corresponding to the motor's thin plate 710 which is fastened to the holding end 91 by means of the three fixing screws 23 used in the former design. The reason why the three fixing screws 23 cannot be substituted is to match up with the original design of the color wheel motor 71. The holding end 91 is constituted in the form of a plate piece due to the dimension restriction of the three fixing screws 23. The body 93 connects the base 92 and the holding end 91 in a triangle configuration, wherein the body 93 forms the triangle to have the base 92 as a side of the triangle and the holding end 91 positioned at an angle opposing to the side, thereby the installation frame 9 is formed to be a firm installation structure which is isolated in construction from the optical device 2 and is substituted for the conventional set-up plate 21.

In this invention, in order to assure the installation position of the color wheel 7, to have sufficient stiffness of the installation frame 9 and to avoid the possible structural interference between the installation frame 9 and the optical device 2, the part from the wall of the color wheel operating tank 70 of this invention, which is used to erect the thin plate 710 of the color wheel motor 71, is removed as shown in FIG. 2.

In this invention, the embodiment of the connecting elements 11 which are used to securely fix the base 92 on the chassis 1 can be screws, as shown in FIGS. 2 and 3, passing through orientation apertures 95 of the base 92 and assembling holes 10 of the chassis 1. Certainly, in other examples, the embodiment of the connecting elements 11 can also be bolts, spiral shafts, rivets or other fixing components or mechanisms with a similar function to the screws.

In this invention, in order to enhance the dynamic isolation of the installation frame 9 on the chassis 1 and to decrease the effect of the operating vibration of the color wheel 7 upon the other components on the chassis 1 of the projection apparatus, a shock absorbing rubber, a compression spring or other materials which may absorb shock and cushion vibration can be disposed on the connecting elements 11 of the installation frame 9 or between the base 92 and the chassis 1. These shock absorbing and vibration cushioning materials are used not only to obstruct the spread of vibration, but also to keep tight combination of the installation frame and the chassis 1.

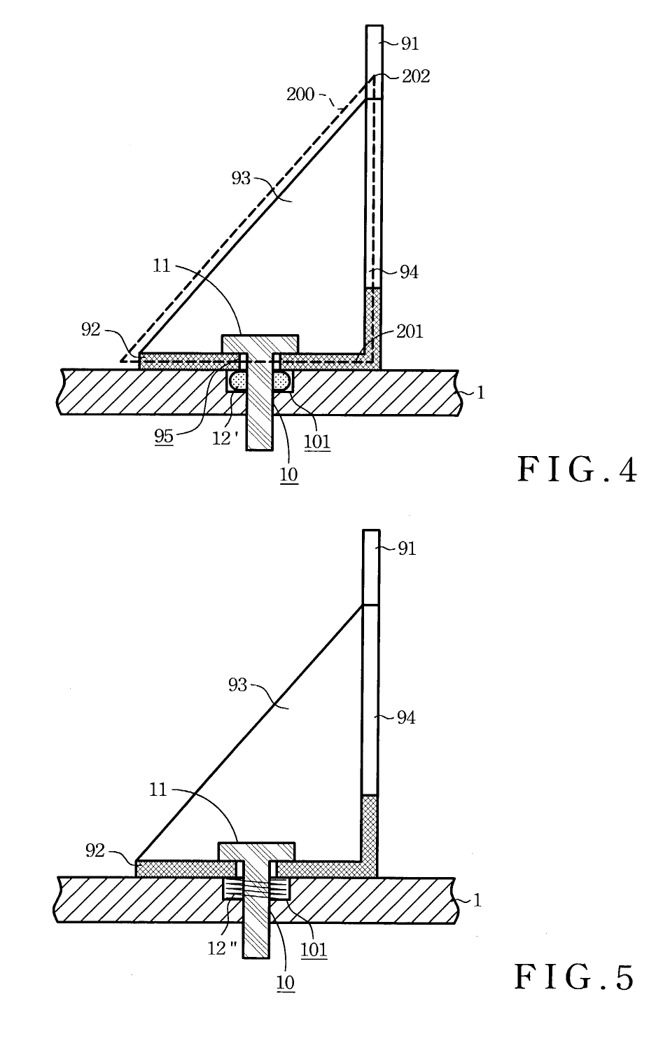

For instance, in the example of FIGS. 2 and 3, each of the screws 11 is collocated with a sheath-type shock absorbing rubber 12 so as to buffer the combination contacts of the screws 11, the base 92 and the chassis 1. Furthermore, in the example of FIG. 4 which clearly shows a triangle configuration 200 of the body 93 as well as a side 201 and an angle 202 respectively corresponding to the base 92 and the holding end 91, the shock absorbing rubber 12′ is a simple ring configuration disposed in an assembling channel 101 of the assembling hole 10 of the chassis 1. In the example of FIG. 5, the shock absorbing rubber 12″ is a compression spring.

In this invention, the installation frame is preferably configured in a piece and can be an aluminum extruded product, a casting, a plastic article or articles made of other materials; wherein considering the shock absorbing property and cost of material, a plastic article is preferred.

Turning to the embodiment of this invention as shown in FIGS. 2 and 3, a proper structural thickness has been provided in the direction of the base 92 and the body 93 parallel to the color wheel 7 to secure the installation frame 9. In addition, at least one reinforced rib 94 can also be mounted on the body 93 of the installation frame 9 so as to provide auxiliary strength and stability of the installation frame 9 in a third direction. (the height direction is a first direction, the direction perpendicular to the color wheel 7 is a second direction, and the direction parallel to the color wheel 7 is the third direction ). As shown in FIGS. 2 and 3, the reinforced rib 94 is exemplified perpendicularly to both the first and the second directions. Certainly, in the other examples, the reinforced rib 94 may also be practiced in the other angles or to enhance the structural thickness of the second direction.

In this invention, the vibration influence of the color wheel motor 71 on the complex optical device 2 is reduced by means of isolating the installation frame 9 from the optical device 2. In one embodiment of this invention, the installation frame 9 is made of plastic, and the shock absorbing rubber 12 as shown in FIG. 2 and the reinforced rib 94 are used. Because of the stability and isolated assembling characteristic provided by the installation frame 9, as well as the plastic to metal attachment formed by the plastic installation frame 9 and the color wheel motor 71, the improved projection apparatus in accordance with the design of the present invention can provide a reduced noise level of below 30 dB which is far superior to 35 dB in the prior art.

As is understood by a person skilled in the art, the foregoing preferred embodiment of the present invention is illustrated of the present invention rather than limiting of the present invention. It is intended to cover various modifications and similar arrangements included within the spirit and scope of the appended claims, the scope of which should be accorded the broadest interpretation so as to encompass all such modifications and variations.

What is claimed:

1. An installation frame for a color wheel assembly of a projection apparatus, for securely installing said color wheel assembly on a chassis of said projection apparatus, said installation frame comprising:
a base, being fixed on said chassis by means of connecting elements;
a holding end for fastening said color wheel assembly; and
a body connecting said base and said holding end in a triangle configuration, wherein said body forms said triangle to have said base as a side of said triangle and said holding end positioned at an angle opposing to said side.

2. The installation frame of claim 1, wherein said connecting elements are a plurality of screws.

3. The installation frame of claim 2, wherein said plurality of screws respectively include a shock absorbing rubber.

4. The installation frame of claim 2, wherein said plurality of screws respectively include a compression spring.

5. The installation frame of claim 1, which is made from plastic article.

6. The installation frame of claim 1, wherein said body includes at least one reinforced rib.
